(19) United States
(12) Patent Application Publication
(10) Pub. No.: US 2016/0199725 A1
(43) Pub. Date: Jul. 14, 2016

(54) Chiralkine

(71) Applicant: Martin Alexander Hay, Prestbury (GB)

(72) Inventor: Martin Alexander Hay, Prestbury (GB)

(21) Appl. No.: 15/079,109

(22) Filed: Mar. 24, 2016

Related U.S. Application Data
(63) Continuation-in-part of application No. 13/882,606, filed on Apr. 30, 2013.

(51) Int. Cl. A63F 3/00; A63F 13/822

(52) U.S. Cl. CPC A63F 3/00063; A63F 13/822; A63F 2003/00066; A63F 2003/00832; A63F 2003/00996

(57) ABSTRACT

A game in which the moves players can make simulate both the symmetric and antisymmetric couplings of muscle pairs that accompany co-ordinated movement of the two sides of the human body, and in which each player's move comprises two components, one beneficial to the player and the other beneficial to the player(s) opponents (herein called chiralkines); a kit for playing the game; an electronic gaming device for use in playing the game; left- and right handed money and left- and right-handed property rights for use in a game or commerce; and apparatuses adapted for use with these.

This application is a continuation-in-part of application Ser. No. 13/882,606 filed Apr. 30, 2013 incorporated by reference herein which is a 371 of international patent application number PCT/GB2011/001583 filed Nov. 11, 2011.

The present invention relates to a strategy game for one or more players. The game can comprise the use of left- and right handed money, which the present invention also provides together with left- and right-handed property rights for use in a game or in commerce, and apparatuses adapted for use with these. A concept described herein as a chiralkine links all these together.

In strategy games, players compete to achieve an objective by making stepwise moves each selected from a set of moves defined by the rules of the game. They are provided with opportunities to conceive and evaluate alternative sequences of moves that they and their opponents could make and to use pattern recognition to guide their decision making as the game progresses.

Games are generally played using a game apparatus compri sing a game field containing token spaces and tokens, each move being represented by movement of one or more tokens in token spaces in the game field. The game field and tokens may be real or virtual, as on a computer screen.

In known games, for example chess, draughts or OTHELLO@, players move their tokens to empower themselves at their opponent's expense. Each player's tokens function (i.e. act) solely on the player's behalf, so that each occupied token space can have one of only two functions: for the player and against the player. Often in two player games, one player uses black tokens and the other white. Thus players think solely in terms of what is in their interest. There is no function represented in the tokens of these games that connects players' interests together.

In real life, people's interests are connected together even when are competing with one another. Many relationships between individuals are antisymmetric, for example creditor/debtor and landlord/tenant relationships. When such antisymmetric relationships are created, a single token is often used to denote them, and as a consequence the antisymmetric function represented by the token can over time become lost from view. For example, money is created whenever two individuals agree that a token can represent a debt incurred in return for receipt of some goods or service. The money may go on to change hands many times, so that after a while, everybody has forgotten that the holder of the money is linked as creditor/debtor to the person that received the original goods or service. Money starts to become viewed as functioning only on its holder's behalf, just like tokens in known games. Unfortunately, when this happens, when everybody forgets that money has an invisible antisymmetric opposite (debt), it sets up conditions for a financial crash or destructive conflict.

Games simulate movement of the human body, because problem solving at its heart is all about solving movement problems, for example how to go from A to B, to catch a ball or to avoid a punch. Competitive games in which players can use movement to assert control over the movement of other players are particularly engaging.

Movement of the human body is effected by the skeletal musculature under the control of the brain. The skeletal musculature is made up of muscle antagonist pairs, the antagonists in each pair being known as the flexor and the extensor. When the body is in motion, one of a flexor and extensor is contracting and the other is relaxing. Motion can be stopped abruptly by contracting both the flexor and extensor at the same time.

There are two fundamental co-ordinated movements of the body: symmetric and antisymmetric. Symmetric movement, as in clapping, results from symmetric coupling of corresponding left and right muscle antagonist pairs. Antisymmetric movement, as in walking, results from antisymmetric coupling of corresponding left and right muscle antagonist pairs. There are two possible antisymmetric couplings. These can readily be distinguished by clapping while walking and noting which foot is forward when the hands are together. They arise as a consequence of the bilateral symmetry of the body. There are also two possible symmetric couplings, but these are indistinguishable. Finally, there are the coupled states when the flexors and extensors are all contracting at the same time. Accordingly, in the human body, there are four possible coupled states: left antisymmetric go, right antisymmetric go, symmetric go and all stop. In a real live contest, as in a fight or a ball game, opponents switch their muscle blocks between these coupled states as they seek to out manoeuvre one another.

Some potential implications of the process of problem solving being linked with the co-ordination of movement are explored in a philosophical novel “Resolution of Zero” by the inventor of the present invention. Copies of this novel were given to the charity shop “Scottish International Relief” based in Lochgilphead, Argyll, Scotland in April, 2009.

A game has now been found in which players can make use of moves that can give rise in the game to functions simulating all four possible coupled states of human muscles. Thus, unlike in known games where a token space can have only two possible functions, in the game according to the invention it can have four.

The game is performed in a game field. In the game field, a player deploys two tokens for each move, each of the tokens representing a function that is the antisymmetric opposite of the other with respect to the players (like debit and credit). The inventor has given these tokens the name chiralkines in recognition that they involve left/right handedness (chirality) and movement (kinetics). As the game progresses, a token can be combined with another already deployed, creating one of two alternative new symmetric functions (with respect to the players) depending upon the order in which the combined tokens have been played. The two symmetric functions are in all the players' interests or against all the players' interests. Accordingly, the game contains elements that link the interests of the players together, as in real life. Optionally, each of the two alternative symmetric functions is represented by a single token, replacing two antisymmetric tokens in combination. The objective of the game is to arrive at a particular arrangement of one or more tokens in the game field.

Accordingly, in one aspect the present invention provides a method for one or more players to pursue a game objective using a game apparatus, wherein:

(a) said game apparatus comprises:

at least two sets of first tokens, one for each player, each set consisting of two kinds of first token (A) and (C) each representing a function that in relation to the players is the antisymmetric opposite of the other;

a set of second tokens (D) and (L) each representing a function that in relation to the players is the symmetric opposite of the other; and a game field provided with a plurality of token spaces;

(b) said game objective is for a player to achieve an arrangement of one or more tokens in the token spaces of the game field that represents a particular function; and
(c) said method comprises a sequence of steps in which each player in turn identifies a first token (C) and a first token (A) to be placed in (+) or removed from (−) different token spaces so as to effect a change in function (>) in each of these token spaces selected from:
none+A>A; none+C>C;
C+A>L; A+C>D;
   and optionally also from:
L+C>C; L+A>A;
D+C>C; D+A>A;
L−A>C; D−C>A;
C−C>none; and A−A>none;
   then moves to change the tokens in each token space accordingly.

The game differs from other games in that each player's move is made up of two antisymmetric opposite components, one beneficial to the player and the other beneficial to the player's opponent(s). Put another way, one component is selfish, restricting the freedom of movement of an opponent, while the other is altruistic, increasing it. These antisymmetric pairings can accumulate as the game progresses. Players must think about how to position both first tokens to their advantage, and make best use of the moves of their opponent(s). Players must also think about the potential outcomes resulting from them or their opponents switching an antisymmetric function to a symmetric function. A symmetric function acts in the same way on all players. It either restricts or increases their freedom of movement.

In addition to providing entertainment, the game has an educational function, as it sensitises players to the differences between symmetric and antisymmetric relationships, and thus to thinking holistically, as the brain has to do when co-ordinating movement. In human society, whenever a right is created, an obligation is as well: a decision to give additional resources to one person is also a decision to take them from another. Societies that lose sight of this have a tendency to fragment, possibly with riots or worse.

In one embodiment, (C) represents a function beneficial to a player, (A) represents the antisymmetric opposite function beneficial to all other players, (L) represents a function beneficial to all players and (D) represents a function beneficial to none of the players. These four alternatives correspond with the alternative couplings of left and right skeletal muscle antagonist pairs: left antisymmetric go, right antisymmetric go, symmetric go and all stop.

The number of players in the game may be one or more, for example 1, 2, 3 or 4. There is no upper limit to the number, especially if the game is played on a web-based computer system. Players may act independently, may collaborate at will or may play in two or more teams.

At the start of the game, the token spaces in the game field may be empty, or one or more token spaces may have tokens in place. For example, alternative patterns of tokens to be deployed at the start of the game can be provided, for example on cards in a pack of cards, or in a booklet. Alternatively, tokens can be deployed by chance, for example using a game field in which the token spaces are in wells and allowing tokens to fall into the wells by chance. In an electronic version of the game, the starting pattern of tokens can be generated using a computer program.

In accordance with the invention, players must play two first tokens on different token spaces, either by placing both of them in the token spaces or removing both of them from the token spaces. Accordingly, players can only make antisymmetric moves.

Placing a first token in an empty token space changes the function of that token space to that of the first token. This corresponds with the following:
none+A>A; none+C>C.

It will be appreciated that two first tokens representing the same antisymmetric function cannot be played consecutively in the same token space, since this would not change the symmetry of the function of that space.

The reverse moves correspond with:
C−C>none; A−A>none.

When two (opposite) first tokens have been placed in the same token space, the function in the space becomes one of two symmetric opposites, depending upon the order in which the two first tokens had been played. This corresponds with the following:
C+A>L; A+C>D.

Conveniently the two first tokens can be replaced with the appropriate second token.

Optionally, a first token can be placed in a token space containing a second token, thereby changing the function in that space to that of the first token, irrespective of what kind the second token is. This corresponds with the following:
L+C>C; L+A>A;
D+C>C; D+A>A.

Conveniently, the second token is removed before the first token is placed in the token space. In this embodiment, it is possible for the function of a token space to change between all four symmetric and antisymmetric functions during the course of a game.

In another embodiment, a second token in a token space can notionally be replaced by the appropriate combination of first tokens, and then the top first token removed. This changes the function of the token space to that of the bottom first token. It is the reverse process to that of combining two first tokens. It corresponds with the following:
L−A>C; D−C>A
   Thus, addition to and subtraction from second tokens are not the same.

Replacing a pair of first tokens with a second token destroys the memory of which player's first tokens made up the pair. When a player changes the function of a token space containing a second token by removing a first token, the second token is replaced with the player's opposite first token.

The features of removing first tokens, of adding a first token to a second token and of removing a first token from a second token are optional features of the game. The game can be played with only the features that correspond with:
none+A>A; none+C>C;
C+A>L; A+C>D;
   Restricting the game to these features shortens the duration of the game, because token spaces become filled up.

It will be appreciated that the presence of a first or second token in a token space denotes one of four possible functions: two antisymmetric and two symmetric. A token space that contains no token (identified herein as none) has no function. A first token can be placed in it, but cannot be removed from it. In order for the game to allow for a first token to be removed from a token space that contains no token, it would be necessary to specify a token with which it would have to be replaced. This would be undecidable, because the inverse operation could be performed by adding either of the two possible first tokens to an empty token space or a token space containing either of the two possible second tokens.

The game can be simplified by deeming an empty space to be a space containing a token. In order not to discriminate between the players, it should be deemed to be a second token, preferably one representing a function that is beneficial to none of the players. Under such circumstances, the only possible changes of state in a token space correspond with the following changes in function:
C+A>L; A+C>D;
L+C>C; L+A>A;
D+C>C; D+A>A.
   In this embodiment, there is no option of removing a first token. Initially, it is this embodiment that is being claimed in the main claim, but Applicant reserves the right to present claims to claim all originally disclosed subject matter.

Accordingly, in one embodiment, the present invention provides a method as described hereinabove in which in step (c) the change in function (>) in each of the token spaces is selected only from:
C+A>L; A+C>D;
L+C>C; L+A>A;
D+C>C; D+A>A.
   Thus, in this embodiment, all token spaces must start out occupied (including deemed occupied) with a first or second token. Conveniently they all start out occupied (or deemed occupied) by a second token D.

Table 1 below provides an example of a game field according to this embodiment, wherein the first tokens of first and second players are denoted by A¹, C¹ and A², C² respectively.

TABLE 1
Game Field Populated by Tokens Showing each of the
Four Possible Symmetric and Antisymmetric States.

| | | | | | | | |
|---|---|---|---|---|---|---|---|
| D | D | D | L | D | D | D | A² |
| D | D | D | L | D | D | D | D |
| D | D | D | C¹ | D | D | D | D |
| D | D | D | L | D | D | A¹ | D |
| D | D | D | D | D | D | D | D |
| D | D | D | L | D | D | D | D |
| D | D | A¹ | D | D | D | D | D |
| D | D | C² | C¹ | D | D | D | D |

It is implicit in this definition that the switching of functions in the token spaces can be thought of in terms of clockwise or anticlockwise rotation between four alternatives (spin), always switching between a symmetric and an antisymmetric function, never between two symmetric and two antisymmetric functions. The switching is analogous to switching between purely real and purely imaginary numbers in Euler's mathematical formula:

e^{iθ}=cos θ+i sin θ

and its three derivatives (calculus): i cos θ−sin θ; −cos θ−i sin θ; and −i cos θ+sin θ. The two sinusoidal components can be represented with two arrows, the left arrow being the real component and the right arrow being the imaginary component. An up arrow signifies positive and a down arrow negative. The four possible states in token spaces (two symmetric and two antisymmetric) map to these:

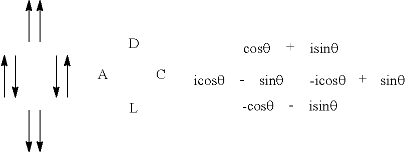

The two symmetric states can be thought of as real (+1 and −1) and the two antisymmetric states as imaginary+/−i, or invisible, zero or undecidable. The idea that zero is undecidable until it has been resolved into two opposites underlies the story in the aforementioned novel, “Resolution of Zero.” This way of looking at the antisymmetric states is exploited in another embodiment of the game, in which two different but connected games can be played at the same time by two different participants. The key to this is that the function of first tokens is undecidable to some of the participants—they can just see nothing, or a blur, as if the first tokens are rotating very fast. For these participants the two second tokens denote simple opposite functions, and the two first tokens each denote the same zero function.

An example of this is shown in Table 2, which corresponds with the game field shown in Table 1.

TABLE 2
Alternative Perspective Of Game Field as in Table 1 Populated by
Tokens Showing the Two Possible Symmetric States, but the
Two Possible Antisymmetric States as Indistinguishable Blank Spaces

| | | | | | | | |
|---|---|---|---|---|---|---|---|
| D | D | D | L | D | D | D | |
| D | D | D | L | D | D | D | D |
| D | D | D | | D | D | D | D |
| D | D | D | L | D | D | | D |
| D | D | D | D | D | D | D | D |
| D | D | D | L | D | D | D | D |
| D | D | | D | D | D | D | D |
| D | D | | | D | D | D | D |

Non-player participants of the game can be told whether they should consider the antisymmetric first tokens to be the same or different, but it is preferable that they actually see the first tokens as they are supposed to. (If they can see the first tokens, they can end up taking sides as between the players). One way of doing this would be for the players to use a game field having more than one face, for example a pair of opposed faces. On one face, the different first tokens can be seen, and on another they appear the same, but different from the two second tokens. For example, the game field can be embodied in a sheet of glass upon which the game tokens can be affixed, and the first tokens can be provided on only one of their sides with information about their antisymmetric function (e.g. black or white on one side and grey on the other). Alternatively, the first tokens may be provided with a distinguishing feature requiring a sensory capability that a non-player participant is deprived of. For example, the first tokens can be provided with colours that can be masked by wearing coloured spectacles, or which a non-player participant cannot discriminate between, because the non-player participant is colour blind. In an electronic game, the different faces of the game field can be displayed on different screens. (The term non-player participant is used hereinabove to distinguish from player).

Now, assume that the game is played such that L is a function beneficial to all players and D represents a function beneficial to none of the players. A second game can now be played in which one or more non-player participants hunt for L tokens in the game field, and upon capturing them convert them into D tokens (flipping them from one symmetric function to its symmetric opposite). These participants are hereinafter referred to as hunters. Collaborative play leading to the deployment of L tokens is countered by a different activity that has the opposite effect. Think of the L tokens being white or “good” and the D tokens being black or “evil”, or the L tokens being photosynthesis (sugar and oxygen) and the D tokens respiration (carbon dioxide and water), or the L tokens being life and the D tokens death (in which case the hunters are playing the role of the grim reaper).

For the game to be enjoyable, hunting for tokens needs to present a level of difficulty (a challenge) that preferably requires the exercise of a level of skill. One option is to define a first token as a token that denotes a function that is beneficial to none of the hunters (e.g. none may enter the token space), a D second token a function that is beneficial to all of the hunters and an L token as a function that, upon capture confers a benefit to the capturer relative to any other hunter (e.g. a points score). For example, a hunter can be provided with two hunting tokens each of which can slide in a straight line from one point to another over D tokens, but not over first tokens. An L token becomes captured when it becomes sandwiched between two hunting tokens, or when both hunting tokens are brought over it. Skill is required to plan a series of moves to effect a capture. Moreover, two or more hunters can compete to be the first to effect a capture.

Thus the hunters can keep the number of D and L tokens in a dynamic balance, rather like a predator can affect the population of its prey. This ensures a more competitive game between the players, as they are obliged to place more reliance on their antisymmetric moves in the development of their game strategies. Thus a player cannot assume that an L token will remain in place for any length of time. Without the hunters, L tokens tend to accumulate in the game field. This is because a player can deploy an A token (which denotes a function that is beneficial to all other players) on top of a C token, thus making the token space beneficial to the player as well as all the other players. In other words, the player is able to use an A token to the player's advantage (as well as the advantage of the other players).

Accordingly, in another embodiment, the present invention provides a method as described hereinabove wherein

(a) said game apparatus further comprises at least two hunting tokens;

(b) said game apparatus is used by at least one hunter during the course of a game between the players; and

(c) said at least one hunter interprets the first tokens A and C as having the same zero function, and the second tokens (L) and (D) as having simple opposite functions, the objective of the hunter being to take a turn between turns of the players and in that turn move one or both of the said hunting tokens to effect capture of an (L) token, convert it to a (D) token and thereby score a point.

In yet another embodiment, the game field has a face upon which first and second tokens are played and another face upon which hunting tokens are played.

It will be appreciated that one or more hunters may participate. A hunter may score whenever an L token is captured. Hunters can compete with one another to secure the highest score before the game ends, which is when the players have achieved their game objective. If desired, the players and hunters can swap roles, so that each can be tested in both roles and a comparison made between their performances in each. Alternatively, a scoring system universal to the two games can be devised. In this universal scoring system, players score each time they achieve a game objective, and then the game resumes with a new game objective. Experimentation is required in order to calibrate the value of a unit hunter score with the value of a unit game objective score. Players and hunters can then continue to play for an arbitrary length of time, and add up their scores at the end. Interestingly, the game played in this way is independent of time. Like the human body, it is a kind of model for a perpetual motion machine, in which the muscle antagonist pairs switch back and forth between symmetric and antisymmetric couplings as the body walks, jumps and otherwise moves along. The only thing that changes is the score, which contains a “memory” of what has happened in the game. This depends upon the “arbitrary” start and end times. The accumulating score (memory of the past), like increasing entropy defines an arrow of time.

In another embodiment, hunters may play collaboratively, or in teams: a pair of hunters each using one of their hunting tokens to effect capture of an L token. For example, each hunter may be provided with a left- and a right-hunting token, capture of an L token being effected when a pair of hunters make use of a right-hunting token of one hunter and a left-hunting token of another hunter. The left- and right-hunting tokens can, optionally, be required to be placed respectively under the control of the left and right hands of the hunters.

It is interesting to note that the experiences of the hunters and players appear to parallel the workings of the conscious and unconscious mind. Thus, the hunters observe L, D and zero, but the players “think” using all four symmetric and antisymmetric states. What is observed and what is thought may not be the same, because of hidden antisymmetric states. Thus, to go back to a point made in the introduction to this specification, clapping and walking are not the same. If you start clapping while standing with the feet together, then start walking while still clapping, the “beat” of the clapping has to go through a 90 degrees phase shift in order to fit with the “beat” of the walking. This is because the first step in walking is only half that of all subsequent steps. It corresponds in the game with placing a first token in a token space containing a second token (or no token). You cannot switch to the other walking mode (left foot forward first rather than right foot forward first) without first undergoing another 90 degrees phase shift into a symmetric (clapping) state. If what is observed and what is thought could differ, due to hidden antisymmetric states (states that cannot be observed), then the scientific method may have limitations.

Everyone is familiar with the phrase: “seeing is believing”. The scientific method consists of collecting data through observation and experimentation and formulating and testing hypotheses. But with the human mind, what you observe might not be what you think. The train of human thought might best be described by the switching of two antisymmetric waves having the same phase between a symmetric and two alternative antisymmetric couplings, reflecting how the brain and muscle antagonist pairs work together to effect co-ordinated movement. This might result in the observation systems of the brain (senses) working in a way connected to but different from the hypothesis processing systems (reasoning). It might create a kind of particle (senses)/wave (reasoning) duality. Man the hunter may be incapable of “seeing” the full picture.

A more detailed explanation of the theory underlying the present invention is provided in the specification for the third priority document, GB 1117954.6 filed on 18 Oct., 2011.

In one embodiment, each player must play a first token (A) that is beneficial to the other player(s) before playing a first token (C) that is beneficial to the player.

In another embodiment, musculature on one side of the player's body is used to effect changes in function corresponding with placing a first token (C) or removing a first token (A) and the opposite side is used to effect changes in function corresponding with placing a first token (A) or removing a first token (C). Players can thus accommodate to the idea that one side looks after the selfish component of their move and the other the altruistic component.

People are generally right-handed (right dominant) or left-handed (left dominant). In one embodiment, musculature on the subordinate side of the player's body is used to effect changes in function corresponding with placing a first token (C) or removing a first token (A) and musculature on the player's dominant side is used to effect changes in function corresponding with placing a first token (A) or removing a first token (C). In another embodiment, it is the musculature on the dominant side of the player's body that is used to effect changes in function corresponding with placing a first token (C) or removing a first token (A).

The right skeletal musculature lies under the control of the left side of the brain, and the left skeletal musculature lies under the control of the right side of the brain. However, higher thought process, such as in forward thinking and pattern recognition, are handled asymmetrically by the two sides of the brain. The brain is able to convert instructions from those asymmetric regions of the brain into instructions that can be distributed to the left and/or right musculature. The brain is also plastic, meaning that it can reassign functions to different brain areas. This is important when learning new skills. It is also important after brain damage, for example following stroke or traumatic brain injury. It is believed that use of a device that links respective opposite antisymmetric functions to respective left and right control may promote brain restructuring, in particular to a more symmetric distribution of higher thought processing as between the two brain hemispheres. In other words, the higher brain processing may become more holistic. Moreover, players that have suffered brain damage in one hemisphere may find that an area in the other hemisphere increasingly handles functions previously handled by the damaged area of the brain. This restructuring would arise, because the brain would recognise that the two antisymmetric opposite functions are interlinked.

In order to control against any advantage inherent in being the first person to play, the game may be repeated such that each player takes a turn to start. Two players may thus, for example, compete in an even number of games, for example a set of 6, 8 or 10 games. The players may compete, for example, until one player has a score at least two above that of any opponent. A numerical score for the total number of victories of each player may be kept, and the overall winner judged to be the player with the highest total score.

In an alternative embodiment, the game apparatus further comprises two kinds of scoring tokens, each scoring token representing a function that is the opposite of the function of the other. Hereinafter, these scoring tokens are referred to as left-handed scoring tokens (L-ST) and right-handed scoring tokens (R-ST). At the conclusion of a game (between players or hunters), the winning player receives a R-ST and the loser(s) a L-ST. A player who wins several games will accumulate R-STs, one for each victory, whereas one that loses several games will accumulate L-STs. However, a player may not simultaneously hold both an R-ST and an L-ST: the two tokens “annihilate” one another like matter and anti-matter when placed in the possession of the same player. The scoring tokens may take the form of paper notes, like paper money, and may come in different denominations, for example 1, 5, 10, and so on. In one embodiment, the R-STs and L-STs may be labelled respectively as right and left currencies, such as right and left dollars, right and left euros, right and left yen, right and left yuan and right and left pounds. Conveniently the symbols for the currencies may be displayed in mirror writing, or images of left and right hands may be provided.

In one embodiment of the game, possession of an R-ST may confer a power on a player or hunter over another player in possession of an L-ST. For example, a player or hunter may give an R-ST to a player having an L-ST and direct that player to make a particular move, for example to place a first token (A) and/or a first token (C) or one or both hunting tokens, in a particular token space or token spaces. Upon receipt by the directed player or hunter, the R-ST is annihilated by the directed player's or directed hunter's L-ST. Thus, use of a R-ST gives a player control over the future movement of an opponent. An R-ST/L-ST pair thus functions like money. Players and hunters compete with one another for control over the future movement of their opponents, as measured by possession of an R-ST, which functions like money. By accumulating R-STs, players or hunters may acquire an increasing ability to control the future moves of their opponents (just as one might do through accumulating capital in a capitalist economy). Players and hunters can compete, for example, until one player or hunter has complete control over the moves of their opponent, for example by being able to achieve a game objective simply by using all the R-ST's in their possession to direct an opponent to place all of their player tokens to achieve that game objective. In effect, the losing player has been enslaved by, or made an automaton for the winning player. Through intelligent play with chiralkines, a player can achieve control over the movement of an opponent. In a variant of the game, players or hunters may also agree with others to voluntarily place their move under the control of another in return for exchanging an L-ST for an R-ST (rather than compelling a move, which leads to mutual annihilation of the L-ST for an R-ST). Thus, the player or hunter is in effect lending control of their move in return for a promise to have future control over another. This is especially useful in games involving more than two players, as it provides a mechanism whereby players or hunters can trade moves, and hence collaborate.

Accordingly, in one embodiment of the invention, said game apparatus further comprises:

a set of scoring tokens consisting of right-handed scoring tokens (R-STs) and left-handed scoring tokens (L-STs) which can be held by a player only in the alternative, each representing antisymmetric opposite functions such that a holder of a R-ST has power to control the placement in (+) or removal from (−) a token space of a first token by a holder of a L-ST during the turn of the holder of the L-ST; and

said method further comprises the steps of:

asserting the power conferred by an R-ST over a holder of an L-ST by pairing the R-ST with the L-ST, cancelling the R-ST and L-ST pair and effecting the consequent change in function (>) in the token space;

identifying as a winner each player that achieves the game objective, and the other player(s) as losers;

identifying all possible winner/loser pairings;

for each winner/loser pairing, allocating an R-ST to the winner and an L-ST to the loser; and

cancelling any L-ST and R-ST pair held by the same player.

When a game apparatus is used by two or more hunters, the method can further comprise:

identifying as a winner a hunter that has captured the most (L) tokens when the game objective has been achieved, and the other player(s) as losers;

identifying all possible winner/loser pairings;

for each winner/loser pairing, allocating an R-ST to the winner and an L-ST to the loser; and

cancelling any L-ST and R-ST pair held by the same player.

The concept of left-handed money and right-handed money is believed to be novel.

According to another aspect, the present invention provides the use of left-handed and right-handed money in a game or commerce.

When used in commerce, parties to a transaction may exchange right-handed money for goods or services and left-handed money. Banks may lend right-handed money to a purchaser of goods or services and left-handed money to a vendor. Thus, a purchaser must itself sell some goods or service for right-handed money in order to be able to repay its debt to the bank. Similarly, the vendor must itself purchase some goods or service before it can repay its debt to the bank.

With the current monetary system, money is created by banks based upon them treating the loans they have already made as assets belonging to them. In accordance with the present invention, left- and right-handed money are created (or destroyed) at the same time that left- and right-handed property rights are created (or destroyed). This is entirely consistent with the state changes that take place in the game according to the invention. For more details, see Example 8 hereinafter. Examples of property rights that can be in left and right-handed forms are property rights that are registered with a government registry, such as real estate, patents for inventions and public limited liability companies.

According to another aspect, therefore, the present invention provides the use of left- and right-handed property rights in a game or commerce.

A system based upon left- and right handed money would require apparatuses adapted to handle money in both forms, such as cash dispensers, vending machines, etc.

According to another aspect, therefore, the present invention provides an apparatus adapted for use with left and right handed money, selected from:

a bank card, compri sing a machine readable identification code, said card being adapted to handle transactions in left- and right-handed money;

a cash machine adapted to dispense left- and right-handed money (cash);

a cash register adapted to handle and record transactions in left- and right-handed money (cash);

a vending machine adapted to receive money (cash) in one of right- and left-handed forms and dispense it in the other; and

an apparatus for use by a bank, compri sing left- and right handed money and a computer programmed to maintain records of transactions in left and right-handed money.

According to another aspect, the present invention provides an apparatus for use by a lawyer, compri sing documents representing left- and right-handed property rights and a computer programmed to maintain records of transactions in left and right-handed property rights.

The global economy would function quite differently if money were to be replaced with left- and right-handed money in accordance with the present invention. Concepts such as capitalism and socialism/communism would be outdated. Banks would no longer be able to create money freely, and trade imbalances could not build up, because exporters would need left-handed money to effect sales.

The tokens in each set of first tokens may be provided with a player-distinctive appearance. For example, the members of different sets may be provided with a different shape, for example a circular, triangular, square, pentagonal or hexagonal shape; a different colour, for example red, orange, yellow, green, blue, indigo or violet; or different markings, for example symbols such as numbers, letters or mathematical symbols.

The antisymmetric opposites may be represented on opposed faces of the same first tokens with markings, for example markings that are associated with antisymmetric opposites, for example words or symbols signifying left and right, + and − or clockwise and anticlockwise, for example spirals. Alternatively, one first token may be dark and the other light.

The symmetric opposites may be represented on opposed faces of the same second tokens with markings, preferably colourless markings that are associated with symmetric opposites, for example one side might be dark, such as black and the other light, such as white.

In one embodiment, each set of first tokens has a different colour; the first token (C) in each set is dark; the first token (A) in each set is light; the set of second tokens is colourless; the second token (L) is light; and the second token (D) is dark. Players can thus associate the selfish component of their move (C) with dark and the altruistic component (A) with light.

In another embodiment, the opposite functions of the first and second tokens are represented respectively on opposite sides of the same tokens.

In yet another embodiment, the game apparatus comprises a timer. The timer may be, for example, electronic or mechanical, such as an alarm clock or sand clock. The timer can be used to limit the time available for a player to make a move.

In one embodiment, the game objective is for a player to achieve an arrangement of one or more tokens in token spaces of the game field that connects tokens selected from first tokens (C) in the player's set, first tokens (A) in any other player's set and second tokens (L) in a series to form a path. The path may be, for example, from one end or edge of the game field to the opposite end or edge. Alternatively it may be to connect all edges of the game field. For example, the path may be a 3-, 4-, 5- or more-sided polygon wherein the vertices are token spaces. In effect, the players are competing to be the first to find a way to be able to perform a particular combination of movements, represented by a particular combination of tokens.

In another embodiment, the game apparatus further comprises a ball token, the game objective is for a player to move the ball token to a required location and in which a player can take possession of the ball token by placing a first token (C) adjacent to the token space containing the ball token, move the ball onto that token space then move the ball token in a straight line along any path formed by that token and one or more tokens selected from first tokens (C) in the player's set, first tokens (A) in any other player's set and second tokens (L). The required location may be, for example, an edge of the game field, for example opposite to the player, a corner of the game field or a section of an edge of the game field (as in a football goal).

In another embodiment, the game field is square and is provided with a plurality of token spaces arranged in a grid pattern.

The grid pattern may be formed of any shapes that can form an ordered lattice, for example squares (which conveniently can form a square grid) or hexagons (which conveniently can form a hexagonal grid that if large enough can be enclosed in a circular frame).

In yet another embodiment, the number of token spaces is in the range of from 25 to 100. It will be appreciated that when the game field is in the form of a square grid, it will contain a square number of token spaces, for example 25, 36, 49, 64, 81 or 100.

It will be appreciated that the number of tokens used in the game will depend upon the number of players, the number of token spaces in the game field and the particular game rules adopted.

Tokens can be made of any suitable material, for example plastic, card, metal or wood. Conveniently they are all formed of regular shapes, such as circular discs, and can conveniently be of the same size. In one embodiment the two sets of first tokens, one for each player (A¹, A², C¹ and C²) and set of second tokens (D and L) are embodied as faces of a cube. Opposed faces of the cube can be marked, for example, A¹ and C². A² and C^{I}; D and L (or the like), for example as shown in FIG. 6.

When the faces are marked as shown in FIG. 6, the face uppermost when the cube is in a token space can always be aligned the same way after rotation by the left or right hand as shown in FIGS. 8 to 11. Opposed corners can also be marked 1, 2, 3 and 4 (or the like), for example as 1, 1; 2, 2; 3, 3; and 4, 4 (or the like, such as 1↑, 1↓; 2↑, 2↓; 3↑, 3↓; 4↑, 4↓) such that they are also disposed at the corners of two interpenetrating chiral tetrahedrons 1, 2, 3 and 4 and 1, 2, 3 and 4 (FIG. 5) or the like 1↑; 2↑; 3↑; 4↑ and 1↓; 2↓; 3↓; 4↓. When marked in this way, the game can provide an educational tool for developing spatial awareness and also relating this through co-ordinated movement to the creation, transfer and redemption of reciprocal relationships (my right, your obligation; your right, my obligation). See FIGS. 12 to 15.

The game field can be provided on a surface of any suitable material, such as wood, cardboard or plastic. In one embodiment, the game field is provided in plastic moulded so that the token spaces lie in wells. In another embodiment, the kit further comprises a turntable for the game field, so that each player can see and manipulate the tokens in the game field from the same perspective.

In another embodiment, the game apparatus is electronic and the game is played using an electronic device. When the game apparatus is electronic, the components of the game apparatus are virtual, for example displayed on an electronic screen forming a component of an electronic device, such as a computer, mobile phone or other device capable of supporting gaming. When the components are displayed on a screen, players can make their moves by manipulating a game controller such as a keyboard, mouse, joystick, paddle, trackball, throttle quadrant, steering wheel, yoke, pedals, gamepad, motion sensor, voice sensor, light gun or gaming headset (compri sing electrodes positioned to detect brain wave activity). In one embodiment of the invention, the game controller is adapted to receive commands for the antisymmetric function of one of the two first tokens from one side of the player's body and the opposite antisymmetric function from the other side of the player's body. For example, the game controller can have a left detector system for receiving commands relating to one antisymmetric function from the left side of the body's musculature (or right side of the brain) and a right detector system for receiving commands relating to the opposite antisymmetric function from the right side of the body's musculature (or left side of the brain). Thus, in the body (and hence brain) of the players, the two antisymmetric functions are handled by respective left and right sides. In one embodiment, the game controller and computer are configured such that when the game controller is moved, a cursor on the screen is moved. When the cursor has been moved over a token space in which a change of state is desired, the player presses a button on the game controller. Conveniently the game controller is configured symmetrically with left and right sides having left and right buttons that can be depressed with left or right fingers or thumbs. In one embodiment the in which the game controller is a cube having opposed faces and corners and the buttons are positioned on said opposed faces and corners. For example the controller can be configured like a cube as shown in FIG. 6 which embodies two sets of first tokens, one for each player (A¹, A², C¹ and C²) and a set of second tokens (D and L).

When the controller is configured as a cube in this way, it can be used to control rotation through the states of tokens in token spaces, for example as shown in FIGS. 7 to 10. The computer can be programmed so as to recognise when a game objective has been met and stop the game. When the game objective is a path, the computer may be programmed to highlight the completed path on a screen.

It will be appreciated that the computer code used in programs to manage the game electronically needs to contain algorithms that can deal with switching between antisymmetric and symmetric states. Thus, representing the antisymmetric states as C for clockwise and A for anticlockwise, and the symmetric states as D for dark and L for light, the following sequences can arise:—

| | | | |
|---|---|---|---|
| C + A > L | A + C > D | L + C > C | L + A > A |
| D + C > C | D + A > A | L − A > C | D − C > A |

According to another aspect, the present invention provides kit for playing a game as described hereinabove, which comprises in physical form:

(a) a game apparatus compri sing:

at least two sets of first tokens, one for each player, each set consisting of two kinds of first token (A) and (C) each representing a function that in relation to the players is the antisymmetric opposite of the other;

a set of second tokens (D) and (L) each representing a function that in relation to the players is the symmetric opposite of the other; and

a game field provided with a plurality of token spaces;

(b) rules providing that the game objective is for a player to achieve an arrangement of one or more tokens in the token spaces of the game field that represents a particular function following the method of the game; which method comprises a sequence of moves in which each player in turn identifies a first token (C) and a first token (A) to be placed in (+) or removed from (−) different token spaces so as to effect a change in function (>) in each of these token spaces selected from:
none+A>A; none+C>C;
C+A>L; A+C>D;
   and optionally also from:
L+C>C; L+A>A;
D+C>C; D+A>A;
L−A>C; D−C>A;
C−C>none; and A−A>none;
   then moves to change the tokens in each token space accordingly.

The antisymmetric opposites may be represented on opposed faces of the same first tokens with markings, preferably markings that are associated with antisymmetric opposites, for example words or symbols signifying left and right, + and − or clockwise and anticlockwise.

The symmetric opposites may be represented on opposed faces of the same second tokens with markings, preferably markings that are associated with symmetric opposites, for example one side might be black and the other white.

In one embodiment, said first tokens comprise two or more sets, the members of each of which are provided with a different player-distinctive appearance. For example, the members of different sets may be provided with a different shape, for example a circular, triangular, square, pentagonal or hexagonal shape; a different colour, for example red, orange, yellow, green, blue, indigo or violet; or different markings, for example symbols such as numbers, letters or mathematical symbols.

The kit can contain two, three, four, five, six, seven or more sets of first tokens, depending upon how many players are intended to use the kit in a game. The number of first tokens in each set depends upon the number of token spaces in the game field, and whether or not the tokens contain representations of the antisymmetric opposite functions on their opposed faces. For example, each set of first tokens may contain in the range of from 2 to 100 first tokens (A) and 2 to 100 first tokens (C) or from 2 to 100 first tokens (A) and (C).

The kit can contain, for example, from 2 to 100 second tokens (D) and from 2 to 100 second tokens (L) or from 2 to 100 second tokens (D) and (L).

In one embodiment, the kit comprises a ball token. In another embodiment, the kit comprises a timer. In yet another embodiment, the token spaces in the game field are in wells. In a variant of this embodiment, the kit further comprises a lid, for example of transparent plastic that can be placed over the game field with tokens trapped inside, such that tokens may be randomly assigned to token spaces by shaking.

In another embodiment, the rules in the kit provide that the change in function (>) in each of the token spaces is selected only from:
C+A>L; A+C>D;
L+C>C; L+A>A;
D+C>C; D+A>A.

In yet another embodiment, the kit further comprises at least two hunting tokens; and the rules provide that:
(b) said game apparatus is used by at least one hunter during the course of a game between the players; and
(c) said at least one hunter interprets the first tokens A and C as having the same zero function, and the second tokens (L) and (D) as having simple opposite functions, the objective of the hunter being to take a turn between turns of the players and in that turn move one or both of the said hunting tokens to effect capture an (L) token, convert it to a
(D) token and thereby score a point.

In yet another embodiment, the game field has a face upon which first and second tokens are played and another face upon which hunting tokens are played.

According to another aspect, the present invention provides electronic gaming device for use by one or more players in a method as described hereinabove, which comprises:

(a) display means for displaying a game apparatus compri sing at least two sets of first tokens, one for each player, each set consisting of two kinds of first token (A) and (C) each representing a function that in relation to the players is the antisymmetric opposite of the other; a set of second tokens (D) and (L) each representing a function that in relation to the players is the symmetric opposite of the other; and a game field provided with a plurality of token spaces;
(b) a game controller adapted to receive two instructions from each player regarding placement of first tokens in token spaces in the game field, one of which is for a first token (C) and the other for a first token (A);
(c) data processing means for converting said instructions into output for the display means such that functions are displayed in token spaces according to at least the following play sequences:
none+A>A; none+C>C;
C+A>L; A+C>D.

In one embodiment, in which the data processing means is also capable of converting said instructions according to the following play sequences:
L+C>C; L+A>A;
D+C>C; D+A>A.

It will be appreciated that such a device is capable of supporting play of a game in which the function of a token space that has become symmetric can be changed by addition of a first token.

Alternatively, or in addition, the data processing means is also capable of converting said instructions according to the following play sequences:
L−A>C; D−C>A;
C−C>none; A−A>none.
   It will be appreciated that such a device is capable of supporting play of a game in which the function of a token space that has become symmetric can be changed by removal of a first token.

The display means can be, for example, a plasma display panel (PDP) or liquid crystal display (LCD).

In another embodiment, the game device further comprises data processing means for recogni sing when the functions of token spaces in combination form a defined pattern, and means for displaying this.

The game controller may be, for example, a keyboard, mouse, joystick, paddle, trackball, throttle quadrant, steering wheel, yoke, pedals, gamepad, motion sensor, voice sensor, light gun or gaming headset (compri sing electrodes positioned to detect brain wave activity).

In yet another embodiment, the game controller is adapted so that one part receives an instruction from the left side of a player's body and the other part receives an instruction from the right side of the player's body. Such a controller can possess bilateral symmetry.

In another embodiment, the electronic gaming devise further comprises

(d) display means for displaying at least two hunting tokens and said first and second tokens, but in which the first tokens all appear the same;

(e) a game controller adapted to receive two instructions from a hunter, one for the movement of each hunting token; and

(f) data processing means for converting the display of a second token (L) on both display means from (L) to (D) when said moves of said hunting tokens have effected capture of said second token (L).

In yet another embodiment, the data processing means is also adapted to display right-handed scoring tokens (R-STs) and left-handed scoring tokens (L-STs) and said controller is adapted to receive instructions regarding play of said R-STs and L-STs.

Preferably the electronic device does not emit an annoying beep when its power supply is running low or it has been left idle for a period.

### BRIEF DESCRIPTION OF THE DRAWINGS

FIG. 1 shows the game field populated by tokens A¹, A², C¹, C², D and L in token spaces as depicted in Table 1, as interpreted by a pair of players.

FIG. 2 shows the game field populated by tokens in token spaces as depicted in Table 2, as interpreted by hunters.

FIG. 3 relates the kinds of state A, C, D and L represented by tokens to two ordered polarities.

FIG. 4 relates the states represented by tokens A¹, A², C¹, C², D and L as shown in Table 1 and Table 2 to four ordered polarities.

FIG. 5 shows a cube composed of two interpenetrating tetrahedrons 1, 2, 3, 4 and their polar opposites 1 (not 1), 2 (not 2), 3 (not 3), 4 (not 4).

FIG. 6 shows a cube as shown in FIG. 5 marked up with the token states A¹, A², C¹, C², D and L and each face of the cube when the cube has been rotated so that the face is up in a token space (see also FIG. 11).

FIG. 7 shows left and right hands marked to show the left thumb (LT), left finger (LF), right thumb (RT) and right finger (RF).

FIG. 8 shows a model of a cube as depicted in FIG. 6 held by left and right hands in the left thumb (LT), left finger (LF), right thumb (RT) and right finger (RF).

FIG. 9 shows a clockwork cycle of rotations of the cube from state A¹ back to state A¹ in which the left and right hands alternate as a pair of pivots about opposed cube corners and a pawl and ratchet.

FIG. 10 shows a clockwork cycle of rotations of the cube from state L back to state L in which the left and right hands rotate the cube about opposed cube faces.

FIG. 11 shows the game field populated with tokens as shown in FIG. 1 with the states interpreted as shown in FIGS. 4 to 10.

FIG. 12 shows possible states of a Buyer and Seller with respect to a good or service in accordance with Example 8.

FIG. 13 shows how a change in state as shown in FIG. 12 corresponds with inversion of two of four ordered polarities.

FIG. 14 shows how changes of state as shown in FIG. 13 can be coupled together by swapping two of four polarities.

FIG. 15 shows how changes in state from D to L (Buyer) and from L to D (Seller) can be coupled together with changes of state as shown in FIG. 14: exchanging left handed money for right handed money to transfer ownership of a good or service in one step.

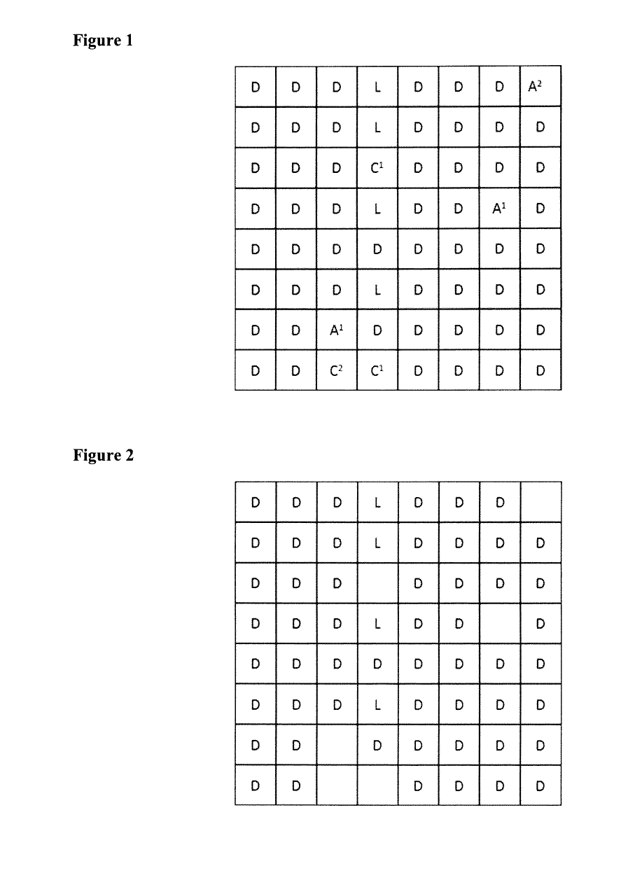

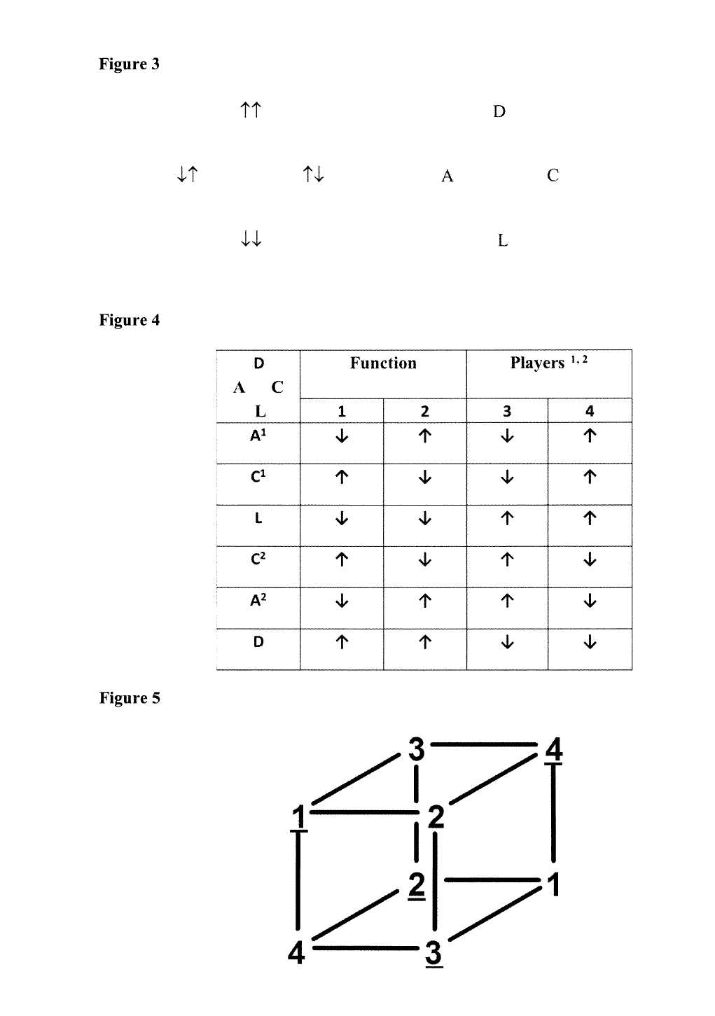

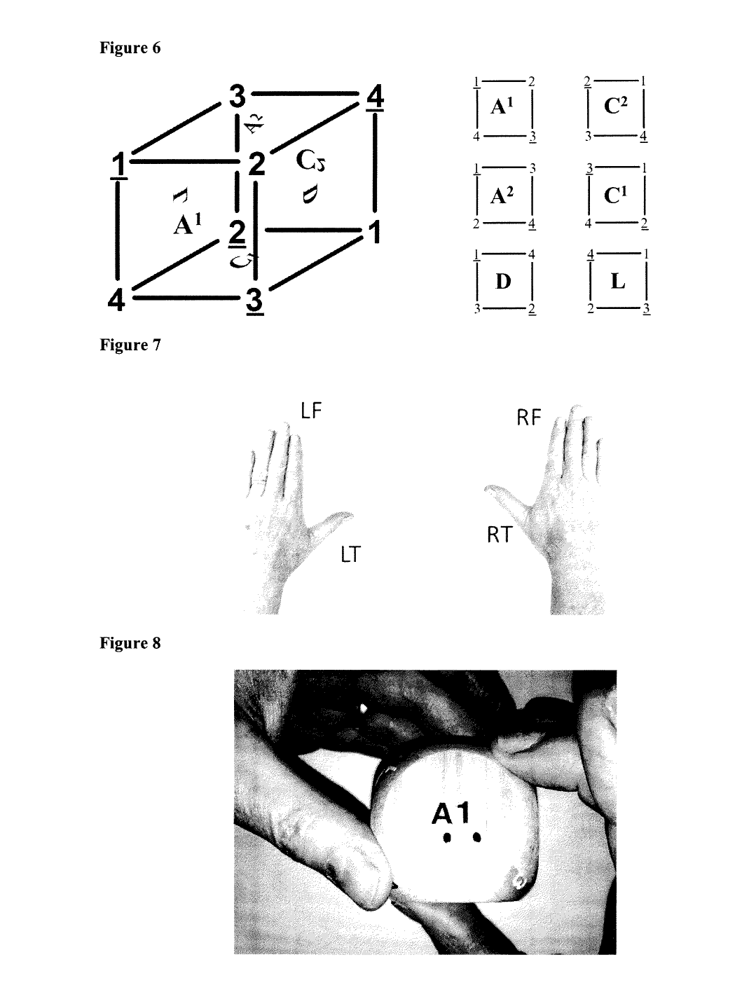

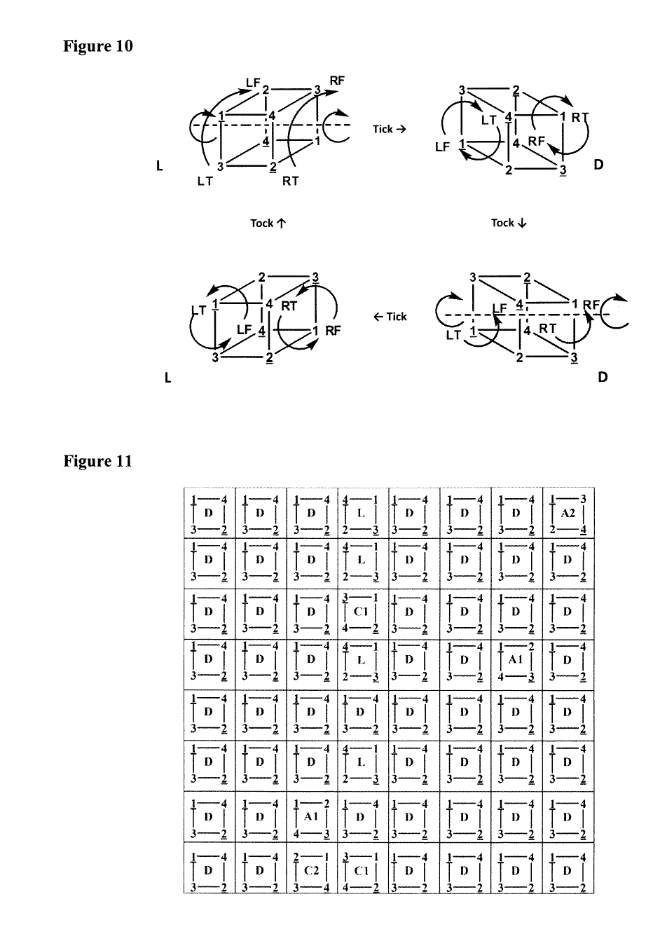

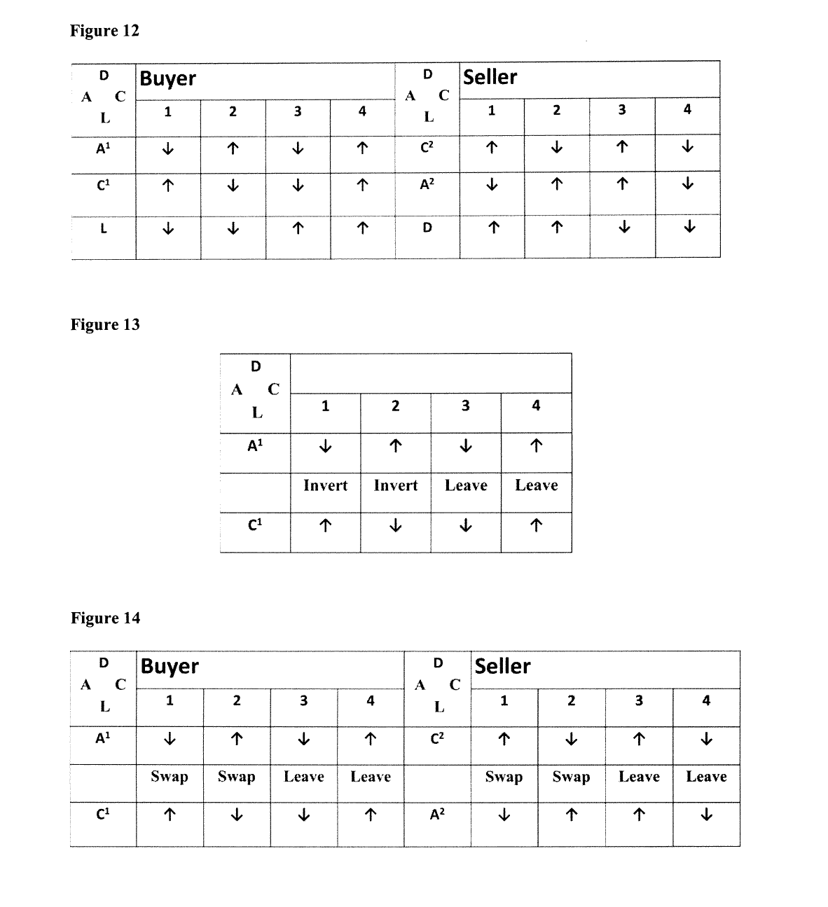

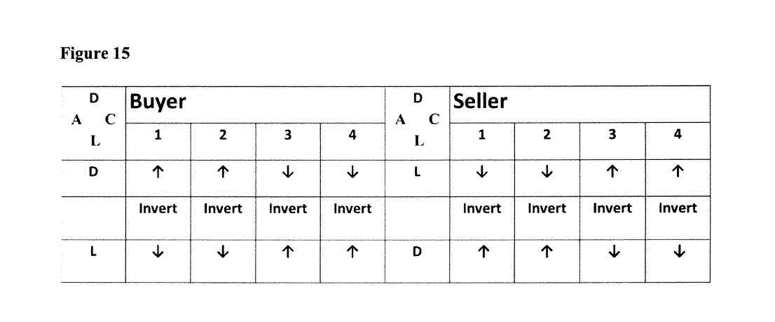

Referring to Example 8, a good or service owned by a Seller, not a Buyer is in state L to the Seller and D to the Buyer. When the ownership of the good or service is transferred from the Seller to the Buyer, it changes state from L to D with respect to the Seller and from D to L with respect to the Buyer. This corresponds with inversion of all four ordered polarities as shown in FIGS. 10 and 15. It takes place when the Seller and Buyer exchange left handed money for right handed money. This exchange of left handed money for right hand money corresponds with coupled state changes from A¹ to C¹ and C² to A², as described below.

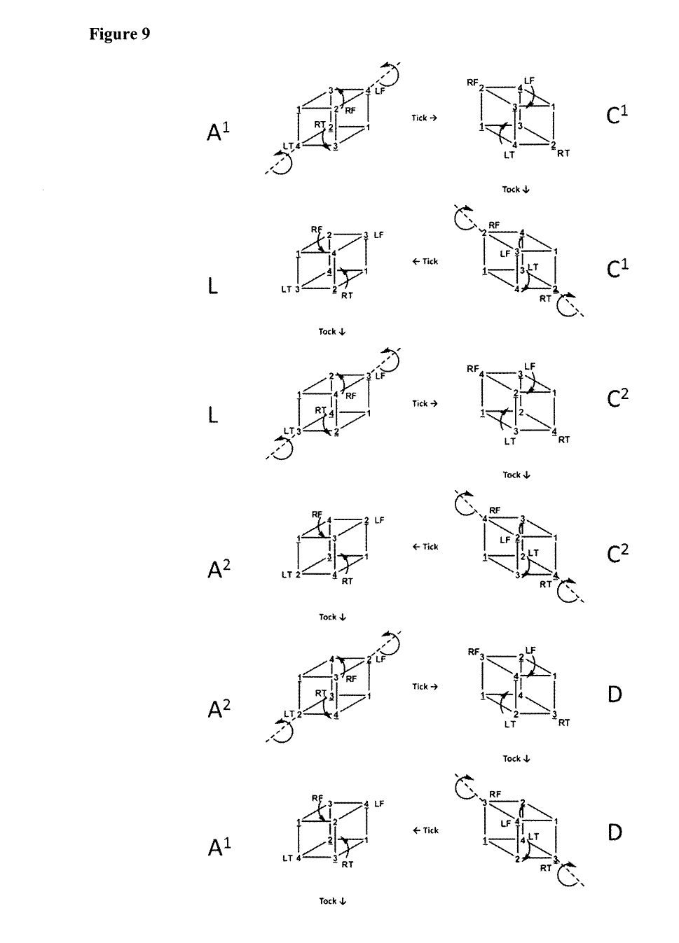

Left handed money and right handed money are created when a Buyer and a Seller enter into a contract to transfer the ownership of a good or service stepwise. When the contract is opened the Seller goes from state L to state C² and the Buyer goes from state D to state A¹ as shown in FIG. 9. This step corresponds with the creation of left handed and right handed money. At this point in time, the good or service is in a transition state of ownership. It could be locked away. When the Seller buys something by exchanging right handed money for left handed money, the state goes from C² to A² as shown in FIGS. 9 and 14. When the Buyer sells something by exchanging left handed money for right handed money, the state goes from A¹ to C¹ as shown in FIGS. 9 and 14. When the Buyer and the Seller have changed states to A² and C¹ respectively, the contract can be closed and the states of the Buyer and seller changed to L and D respectively, as shown in FIG. 9. This corresponds with the redemption of left handed money and right handed money. The coupled state changes have ensured that the Buyer and Seller have each transferred in and transferred out a good or service in balance over a cycle of exchange under control of a contract. The mechanism is the same as that which couples players and hunters together in the game embodiment of the invention.

The following examples illustrate the invention.

### EXAMPLE 1

### Game for 2 Players

A game apparatus is assembled from the following elements:—

A game board compri sing a square game field provided with a grid of 64 square token spaces (8 rows and 8 columns); thirty red and thirty blue first tokens each being circular discs bearing an “R” on one face and an “L” on the opposite face; and thirty second tokens each being circular discs that are black on one face and white on the opposite face.

The object of the game is to be the first player to create a path from their side to the opposite side.

The tokens represent the following functions:

Face of first token bearing L—only token player permitted
Face on first token bearing R—all players except token player permitted
Face on second token white, equivalent to a first token bearing R on top of a first token bearing L—all players permitted
Face on second token black, equivalent to a first token bearing L on top of a first token bearing R—no players permitted

Players may not place both first tokens in the same token space.

The placement of a token in a token space must result in a change of function at that space. Thus, a first token may only be placed in a token space containing no token, the antisymmetric opposite first token or a second token.

Two players position themselves on opposite sides of the game field. Both players are right handed.

The game commences when one player places two first pieces in token spaces on the game field, firstly a first token R with the right hand then a first token L with the left hand. The other player then does the same. When a second first token is placed over a first, the two first tokens in the token space are removed and replaced with the appropriate second token. The game continues until a player has completed and identified a path from one side to the opposite.

### EXAMPLE 2

### Game for 4 Players

A game apparatus is assembled as described in Example 1, except in that it comprises thirty red, thirty blue, thirty yellow and thirty green first tokens each being circular discs bearing an “R” on one face and an “L” on the opposite face.

The game objective and game rules are as described in Example 1.

The four players arrange themselves on the four sides of the game field and play in turn.

Optionally they may play independently or in two teams of two players. When they play in teams, the players in each team are positioned opposite to one another.

### EXAMPLE 3

### Game for 2 Players

A game apparatus is assembled from the following elements:—

A game board compri sing a square game field provided with a grid of 81 square token spaces (9 rows and 9 columns); fifty red and fifty blue first tokens each being circular discs bearing an “R” on one face and an “L” on the opposite face; fifty second tokens each being circular discs that are black on one face and white on the opposite face; and a ball token.

The object of the game is to be the first player to get the ball token from the centre of the game field to the opponent's side, or into an area along part of the opponents side that represents the opponent's goal.

During a move, a player may take possession of the ball token by placing a token adjacent to the token space containing the ball token so as to create a function which permits the player to move the ball token onto that token space (corresponding in football with a tackle). The player may then move the ball token in a straight line along all connected token spaces having functions that permit the player to move the ball token onto those tokens space (i.e. kick the ball). If the player can move the ball token all the way to the opponent's side or to the opponent's goal, as appropriate, then the player has won the game.

The tokens represent the following functions:

Face of first token bearing R—only token player permitted to receive ball token
Face on first token bearing L—all players except token player permitted to receive ball token
Face on second token white, equivalent to a first token bearing R on top of a first token bearing L—all players permitted to receive ball token
Face on second token black, equivalent to a first token bearing L on top of a first token bearing R—no players permitted to receive ball token

Players may not place both first tokens in the same token space.

The placement of a token in a token space must result in a change of function at that space. Thus, a first token may only be placed in a token space containing no token, the antisymmetric opposite first token or a second token.

### EXAMPLE 4

### Game for 1 Player

A game apparatus is assembled from the following elements:—

A game box compri sing a sunken square game field provided with a grid of 25 square token spaces (5 rows and 5 columns), said token spaces having the form of sunken wells; a transparent lid for covering said square game field; thirty first tokens each being white circular discs bearing a black “R” on one face and a black “L” on the opposite face; thirty first tokens each being black circular discs bearing a white “R” on one face and a white “L” on the opposite face; thirty second tokens each being circular discs that are black on one face and white on the opposite face; and a timer.

Prior to commencing the game, the lid is inverted and a mixture of 25 first and second tokens is placed inside. The game box is then placed over the lid and the combined box and lid is inverted and shaken until all of the tokens have entered into token space wells. The lid is then removed and the timer is started. The object of the game is for the player to use only white or only black first tokens to create a specific pattern of tokens in the game field during the time allotted by the timer. An example of such a pattern would be a three by three square of alternating black and white second tokens. The game can be repeated with patterns of increased complexity to provide an increased challenge for the player as the player's skill level and dexterity increases.

Alternative patterns can be provided on cards in a pack (from which the player can take one) or in books.

This game can also provide training for players in preparation for competitive play.

### EXAMPLE 5

### Game for Two Players and a Hunter

A game apparatus is assembled from the following elements:—

A game board compri sing a square game field provided with a grid of 64 square token spaces (8 rows and 8 columns); said game field being marked out on a transparent material (such as glass) that is mounted vertically in a stand;
thirty first tokens each being circular discs having one face black with a central red dot and the other face grey;
thirty first tokens each being circular discs having one face black with a central blue dot and the other face grey;
thirty first tokens each being circular discs having one face white with a central red dot and the other face grey;
thirty first tokens each being circular discs having one face white and a central blue dot and the other face grey;
sixty four second tokens each being circular discs having both faces white;
sixty four second tokens each being circular discs having both faces black;
two hunting tokens each being a black disc bearing an image of a human skull;
each of said tokens being provided with a sticky deposit that enables the token to be stuck releasably onto the transparent material in the token spaces of the game field.

The object of the game (for a player) is to be the first player to create a path from their side to the opposite side. The object of the hunter is to capture white tokens and replace them with black.

The tokens represent the following functions to the players on one side of the transparent material bearing the game field:

Face of first token bearing black with a coloured dot—only token player of that colour permitted;
Face on first token bearing white—all players except token player of that colour permitted
White second token white—all players permitted
Black second token—no players permitted

The tokens represent the following different functions to the hunter on the other side of the transparent material bearing the game field.

Gray face (on first token)—hunter not permitted
Black or white second token—hunter permitted

At the start of the game, a black second token is placed in each token space on the player's side of the game field. The hunter then places each of the two hunting tokens in token spaces on the hunter's side of the game field.

Play commences when a player takes a white and a black first piece each bearing a dot of the player's colour (e.g. red), and uses each to replace a black second token (grey face down). In one version of this, the player uses the player's dominant hand to place the white first piece and then the player's subordinate hand to place the black second piece (thus using different sides of the brain to control the moves). The player now sees white and black first pieces in place of two black second pieces, whereas the hunter sees two grey pieces in place of two black second pieces. The player's opponent now takes a white and a black first piece each bearing a dot of the player's colour (e.g. blue). These are now played, replacing one token in each of two token spaces. Again, the player can use the player's dominant hand to place the white first piece and then the player's subordinate hand to place the black second piece. Now it is the turn of the hunter to move. The hunter can slide each hunting token once in a straight line across any token space containing a black or a white second token, but cannot cross any token space bearing a grey first token. If there is a white token in a token space (resulting from a white first token having been placed in a token space that contained a black first token), then the hunter can attempt to capture this. To capture the white second token, the hunter must slide each hunting token so as to sandwich the white token between the two. The white second token is then replaced with a black second token and the hunter scores one point.

The game continues as the players continue to deploy white and black first tokens, the task of the hunter becoming increasingly difficult as the number of token spaces occupied by first tokens (grey to the hunter) increases.

The game ends when a player has succeeded in establishing a chain of token spaces that permits the player to pass from one side of the game field to the opposite side.

The players note who won, and what the hunter's score was, then repeat the game, with one of the players swapping roles with the hunter.

### EXAMPLE 6

### Game for Two Players and Two Hunters

The game apparatus is the same as that for Example 5, except in that it now comprises two pairs of hunting tokens, each pair being provided with a skull of a different colour.

The hunters make their moves between the moves of the players, such that the moves alternate player 1, hunter 1, player 2, hunter 2 and so on.

### EXAMPLE 7

### Game for Two Players and Two Hunters

The game apparatus is the same as that of Example 6, except in that the members of each pair of hunting tokens are marked to signify left and right respectively.

The hunters work collaboratively, capturing white pieces using a right hunting token of one hunter and a left hunting token of the other hunter.

The two players and two hunters then swap roles. The two that succeed in capturing the most white pieces overall are winners (analogous to winners of doubles in tennis).

### EXAMPLE 8

### Use of Left- and Right-Handed Money and Property Rights in Commerce

This example illustrates how changes in the game between the four possible states A, C, L, D in token spaces in the game field and the use of left- and right-handed scoring tokens correspond with the creation and destruction of left and right-handed money and monetary transactions and also with the creation and destruction of left and right-handed property rights and property right transactions.

A property developer P purchases a plot of land on which there is a house and a garden. P forms a new plot by dividing off part of the garden and builds a house on this.

Person Q wishes to buy the new house. P and Q agree that Q may purchase the house from P for 100,000 currency units. In order for this transaction to take place, left- and right handed property rights in the new plot must be created.

Lawyer S, acting for P, creates two documents consisting of left- and right-handed title deeds to the new plot. These are reviewed by Lawyer R acting for Q. S and R both save electronic copies of the documents on their respective computer systems, and also enter the names of P and Q into their respective computerised docketing systems that record the ownership of left- and right-handed property rights.

In order to finance the transaction, P and Q both borrow money from Bank B. Both P and Q have accounts at B, in both LCU and RCU. Each account has one account number for both LCU and RCU.

B appraises the house and agrees that it is worth 100,000 currency units.

B creates (from nothing) 100,000 left-handed currency units (LCU) and 100,000 right-handed currency units (LCU). It lends the 100,000 LCU to P and the 100,000 RCU to Q. The creation of the money is recorded in the financial accounts of the bank. B enters a debit of 100,000 LCU against the account of P and 100,000 RCU against the account of Q in its computer system. The money is transferred electronically to the client bank accounts of S and R respectively.

S and R arrange for 100,000 LCU to be transferred to the bank account of Q and 100,000 RCU to be transferred to the bank account of P. B records these transactions in its computer system. The bank account of P now shows a credit of 100,000 RCU, whereas that of Q now shows a credit of 100,000 LCU.

S and R now apply to register the creation and current ownership of the property rights with the government real estate registry. Since the property rights have been used as security for the loans, this fact is recorded by the registry alongside the ownership of the left-handed property right by P and the right-handed property right by Q. The left-handed property right is secured on the RCU deposited in the bank account of P, the balance of which the bank B holds until the equivalent amount in LCU has been repaid off the loan.

P and Q now pay their lawyers for the services rendered to them. P and S each use their respective bank cards, each card compri sing a machine readable identification code and being adapted to handle transactions in left- and right-handed money. 1,000 RCU is debited from the bank account of P and credited to the bank account of S. 1,000 LCU is debited from the bank account of S and credited to the bank account of P. Q and R use cash, Q giving R 900 RCU and receiving 900 LCU in return.

P now needs some more cash. P withdraws 600 RCU and 50 LCU in banknotes from its bank account using the bankcard and a cash machine adapted to dispense left- and right-handed money. The bank B adjusts the balances of RCU and LCU in P's bank account accordingly.

P then purchases a bottle of a drink for 2 RCU from a vending machine. P inserts a bank note for 5 RCU into the vending machine and receives in return the bottle of drink, 3 RCU in coins and 2 LCU in coins. Next P goes into a shop and buys a new television set for 500 RCU. P pays for this in cash. P receives the television set and 500 LCU. The cashier for the shop uses a cash register containing cash in both left- and right-handed money to receive the 500 RCU and dispense the 500 LCU. The cash register records the transaction and prints a receipt showing the transaction.

P deposits the 500 LCU in its bank account, and directs that this be used to reduce the balance on its loan used to finance the sale of the property to Q. The bank cannot lend out this money. It can only create money secured on left- and right-handed property rights, and can only lend money created by it or deposited with it.

Q gets a job. Q borrows 3000 LCU from the bank, giving this to Q's employer in return for 3000 RCU. Q deposits this in the bank, and directs that 750 RCU be used to reduce the balance on its loan used to purchase the property from P. The bank cannot lend out this money. The bank combines 500 RCU with the 500 LCU paid back by P, and this money is destroyed. The remaining 250 RCU remains credited to Q's loan account.

The bank retains a lien on the left- and right-handed property rights. If either P or Q is in default of its loan obligations, the bank can enforce its rights. If Q is in default, the bank can repossess the right-handed property right, which gives it physical possession of the property, and sell on the right. If P is in default, the bank can freeze the outstanding RCU in P's account until P has repaid the necessary amount of the loan in LCU.

The RCU and LCU created with the creation and sale of the left- and right-handed property rights continue to circulate in the economy. Their value is based upon a real asset: the property purchased from P by Q, the value of which has been agreed by P, Q and the bank. They can be exchanged with goods or services or leant out, just like single currency money, but money cannot be created without the creation of new left- and right-handed property rights and is consumed when these rights are transformed into single property rights.

Eventually both P and Q repay their loans from the bank, at which point their original contract, the performance of which the money was based upon, is completed. All 100,000 RCU and LCU are recombined and destroyed. The left- and right-handed property rights are also combined and transformed, so that Q now becomes the sole owner of the property. The bank then applies to the registry to have the changes recorded by the registry, such that the record of the bank's lien on the left- and right-handed property rights has been removed and Q is the sole registered owner of the property. This single property right continues until it is extinguished, for example abandoned.

Left- and right handed money and left- and right handed property rights function like chiralkines. Referring to the diagram below, left- and right-handed money is created when No Property Right becomes a Left-handed Property Right and a Right-handed Property Right. These exist until the created left- and right-handed money has been recombined, when a single Property Right is formed. This situation continues until the single Property Right is extinguished, becoming a No Property Right once more (akin in the game to when a hunter captures an L token and converts it to a D token).

No Property Right

| | |
|---|---|
| Left-handed Property Right | Right-handed Property Right |

Property Right

Property rights change ownership when they are exchanged together with left-handed money for right-handed money.

1. Left- and right-handed money.

2. An electronic gaming device for use by one or more players, which comprises:
(a) display means for displaying a game apparatus compri sing at least two sets of first tokens, one for each player, each set consisting of two kinds of first token (A) and (C) each representing a function that in relation to the players is the antisymmetric opposite of the other;
a set of second tokens (D) and (L) each representing a function that in relation to the players is the symmetric opposite of the other; and
a game field provided with a plurality of token spaces;
(b) a game controller adapted to receive two instructions from each player regarding placement of first tokens in token spaces in the game field, one of which is for a first token (C) and the other for a first token (A);
(c) data processing means for converting said instructions into output for the display means such that functions are displayed in token spaces according to the following play sequences:
C+A>L; A+C>D;
L+C>C; L+A>A;
D+C>C; and D+A>A.

3. A device as claimed in claim 2, which further comprises:
(d) display means for displaying at least two hunting tokens and said first and second tokens, but in which the first tokens all appear the same;
(e) a game controller adapted to receive two instructions from a hunter, one for the movement of each hunting token; and
(f) data processing means for converting the display of a second token (L) on both display means from (L) to (D) when said moves of said hunting tokens have effected capture of said second token (L).

4. An electronic gaming device as claimed in claim 2, in which the game controller is adapted to receive commands for the antisymmetric function of one of the two first tokens from one side of the player's body and the opposite antisymmetric function from the other side of the player's body

5. An electronic gaming device as claimed in claim 2, in which the game controller has a left detector system for receiving commands relating to one antisymmetric function from the left side of the body's musculature and a right detector system for receiving commands relating to the opposite antisymmetric function from the right side of the body's musculature.

6. An electronic gaming device as claimed in claim 2, in which the game controller has a left detector system for receiving commands relating to one antisymmetric function from the right side of the brain and a right detector system for receiving commands relating to the opposite antisymmetric function from the left side of the brain.

7. An electronic gaming device as claimed in claim 2, which further comprises a timer that can be used to limit the time available for a player to make a move.

8. An electronic gaming device as claimed in claim 2, in which the game controller is configured symmetrically with left and right sides having left and right buttons that can be depressed with left or right fingers or thumbs.

9. An electronic gaming device as claimed in claim 8, in which the game controller is a cube having opposed faces and corners and the buttons are positioned on said opposed faces and corners.

10. A kit for playing a game, which comprises in physical form:
(a) a game apparatus compri sing:
at least two sets of first tokens, one for each player, each set consisting of two kinds of first token (A) and (C) each representing a function that in relation to the players is the antisymmetric opposite of the other;
a set of second tokens (D) and (L) each representing a function that in relation to the players is the symmetric opposite of the other; and
a game field provided with a plurality of token spaces;
(b) rules providing that the game objective is for a player to achieve an arrangement of one or more tokens in the token spaces of the game field that represents a particular function following the method of the game; which method comprises a sequence of moves in which each player in turn identifies a first token (C) and a first token (A) to be placed in (+) different token spaces so as to effect a change in function (>) in each of these token spaces selected from:
C+A>L; A+C>D;
L+C>C; L+A>A;
D+C>C; and D+A>A;
then moves to change the tokens in each token space accordingly.

11. A kit as claimed in claim 10, wherein
said game apparatus further comprises at least two hunting tokens;
said game apparatus is for use by at least one hunter during the course of a game between the players; and
the rules provide that said at least one hunter interprets the first tokens (A) and (C) as having the same zero function, and the second tokens (L) and (D) as having simple opposite functions, the objective of the hunter being to take a turn between turns of the players and in that turn move one or both of the said hunting tokens to effect capture of an (L) token, convert it to a (D) token and thereby score a point.

12. A kit as claimed in claim 11, wherein the game field has a face upon which first and second tokens can be played and another face upon which hunting tokens can be played.

13. A kit as claimed in claim 10, wherein said two sets of first tokens, one for each player (A¹, A², C¹ and C²) and said set of second tokens (D and L) are embodied as faces of a cube.

14. A kit as claimed in claim 13, in which opposed corners of the cube are marked such that they are disposed at the corners of two interpenetrating chiral tetrahedrons 1, 2, 3 and 4 and 1, 2, 3 and 4.

15. A kit as claimed in claim 10, which further comprises a turntable for the game field.
